(19) United States
(12) Patent Application Publication
(10) Pub. No.: US 2022/0300902 A1
(43) Pub. Date: Sep. 22, 2022

(54) Systems And Methods For Cargo Marketplace For Moving Goods

(71) Applicant: Ford Global Technologies, LLC, Dearborn, MI (US)

(72) Inventor: Abraham Mezaael, Southfield, MI (US)

(73) Assignee: Ford Global Technologies, LLC, Dearborn, MI (US)

(21) Appl. No.: 17/202,955

(22) Filed: Mar. 16, 2021

(51) Int. Cl. G06Q 10/08; B60W 60/00; B60W 40/08

(52) U.S. Cl. CPC G06Q 10/08355; B60W 60/00256; B60W 40/08; G06Q 10/0832; B60W 2556/50; B60W 2556/10

(57) ABSTRACT

Systems and methods are provided that allow vehicles to participate in a cargo marketplace. The vehicle may use their cargo space to transport items for other users. The vehicle may initiate a cargo discovery mode that may allow the vehicle to provide information about how much cargo space it currently has. This information may be provided to the system, which may also receive requests from users for vehicles that are capable of transporting certain items. The discovery mode may be automatically initiated based on a geofence or may be initiated through the driver of the vehicle using a mobile device application. The vehicle may be matched to users requesting transport of items based on the size of the cargo space of the vehicle and the size of the items that are requested to be transported.

### BACKGROUND

As the demand of mobile cargo delivery continues to grow, it is desirable that connected vehicles, autonomous vehicles, and other delivery methods are utilized when they can be to achieve maximum opportunity to meet the demand and needs for consumers and businesses. It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a system for providing a cargo marketplace in accordance with the principles of the present disclosure.

FIG. 2 shows some example components that may be included in a cargo marketplace platform in accordance with the principles of the present disclosure.

FIG. 3 is a flow chart illustrating exemplary steps for providing a cargo marketplace in accordance with the principles of the present disclosure.

FIG. 4 illustrates an exemplary cargo marketplace in accordance with the principles of the present disclosure.

### DETAILED DESCRIPTION

### Overview

Systems and methods are provided that allow vehicles to participate in a cargo marketplace. For example, the vehicle may use their cargo space to transport items for other users. The vehicle may initiate a cargo discovery mode that may allow the vehicle to provide information about how much cargo space it currently has. This information may be provided to the system, which may also receive requests from users for vehicles that are capable of transporting certain items. The discovery mode may be automatically initiated based on a geofence, e.g., if the vehicle enters a geofence area including a number of shopping centers, or may be initiated through the driver of the vehicle via an HMI of the vehicle or using a mobile device application. The vehicle may be matched to users requesting transport of items based on the size of the cargo space of the vehicle and the size of the items that are requested to be transported. In some embodiments, the system may include a smart home device, e.g., a smart refrigerator, which may automatically request a specific item based on the learned need of the smart home device's owner.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination to form additional hybrid implementations of the present disclosure. For example, any of the functionality described with respect to a particular device/component may be performed by another device/component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art.

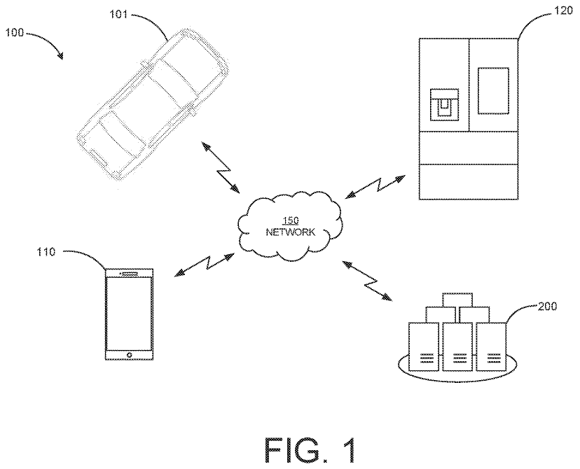

Referring now to FIG. 1, cargo marketplace system 100 is described. System 100 may include a driver device associated with vehicle 101, user device 110, and optional smart device 120, e.g., a smart refrigerator, all communicatively coupled to cargo marketplace platform 200 via, e.g., network 150. Cargo marketplace platform 200 may be located on one or more servers. The driver device and/or user device 110 may be, e.g., a human machine interface (HMI) within the vehicle 101, a smartphone, a tablet, or a smartwatch, which may run a mobile application compatible with cargo marketplace platform 200. The driver device may be operated by a driver of vehicle 101, and/or may be integrated with the control system of vehicle 101. In some instances, the driver device may comprise a human machine interface (HMI) within the vehicle 101.

Vehicle 101 may be a manually driven vehicle (e.g., no autonomy) and/or configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4. A vehicle having a Level-0 autonomous automation may not include autonomous driving features. An autonomous vehicle (AV) having Level-1 autonomy may include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation. Level-3 autonomy in a vehicle can provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task. Level-4 autonomous vehicles can operate independently from a human driver, but may still include human controls for override operation. Level-4 automation may also enable a self-driving mode to intervene responsive to a predefined conditional trigger, such as a road hazard or a system failure. Level-5 autonomy is associated with autonomous vehicle systems that require no human input for operation, and generally do not include human operational driving controls. According to embodiments of the present disclosure, cargo marketplace platform 200 may be configured and/or programmed to operate with a vehicle having a Level-4 or Level-5 autonomous vehicle controller.

In addition, vehicle 101 may have a predefined maximum cargo space therein, which may decrease depending on what objects vehicle 101 may have in the cargo space at a given time. Moreover, vehicle 101 may have a vehicle climate, e.g., temperature within the interior of vehicle 101, which may be adjusted. The driver device associated with vehicle 101 and/or vehicle 101 may include a GPS system configured to provide location data of vehicle 101, as well as a predetermined navigation route being completed by vehicle 101.

Smart device 120 may be, e.g., a smart refrigerator, utilized by a user, such that the smart refrigerator may observe grocery shopping patterns of the user. Based on the user's shopping patterns, e.g., how often the user purchases a specific grocery item and/or when an item within the smart refrigerator is running low and/or expiring soon, the smart refrigerator may determine what grocery item(s) need to be purchased/replaced, and transmit information indicative of the grocery item(s) to be purchased/replaced, e.g., their size and climate requirement, if any, to cargo marketplace platform 200.

Network 150 may include any one, or a combination of networks, such as a local area network (LAN), a wide area network (WAN), a telephone network, a cellular network, a cable network, a wireless network, and/or private/public networks, such as the Internet. For example, network 150 may support communication technologies, such as TCP/IP, Bluetooth, cellular, near-field communication (NFC), Wi-Fi, Wi-Fi direct, machine-to-machine communication, man-to-machine communication, and/or a vehicle-to-everything (V2X) communication.

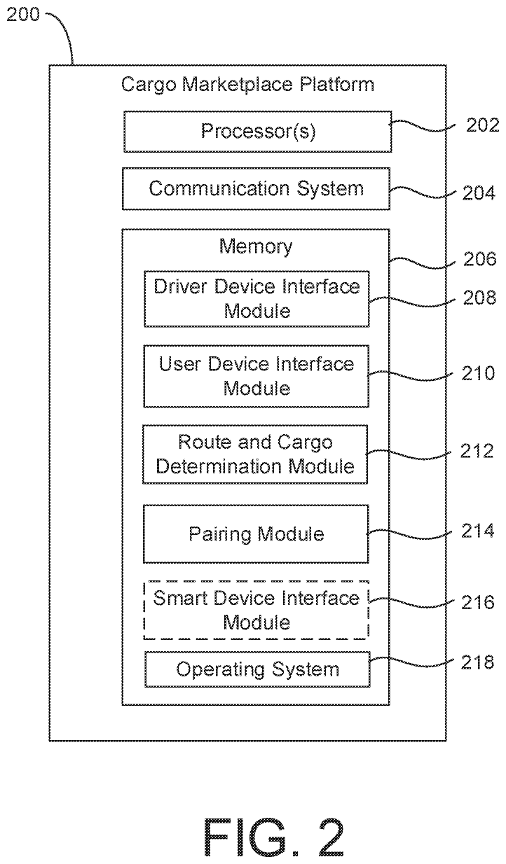

Referring now to FIG. 2, components that may be included in cargo marketplace platform 200 are described in further detail. Cargo marketplace platform 200 may include one or more processors 202, communication system 204, and memory 206. Communication system 204 may include a wireless transceiver that allows cargo marketplace platform 200 to communicate with the driver device associated with vehicle 101 and/or vehicle 101, user device 110, and smart device 120. The wireless transceiver may use any of various communication formats, such as, for example, an Internet communications format, or a cellular communications format.

Memory 206, which is one example of a non-transitory computer-readable medium, may be used to store operating system (OS) 218, driver device interface module 208, user device interface module 210, route and cargo determination module 212, pairing module 214, and optional smart device interface module 216. The modules are provided in the form of computer-executable instructions that may be executed by processor 202 for performing various operations in accordance with the disclosure.

Memory 206 may include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory 206 may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). The computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Driver device interface module 208 may be executed by processor 202 for interfacing with a mobile application running on the driver device associated with vehicle 101 and/or the control system of vehicle 101. For example, driver device interface module 208 may receive information associated with vehicle 101 such as cargo space available and/or vehicle climate, as well as location, speed, and/or current navigation route of vehicle 101. Accordingly, the user of the driver device may manually input vehicle information to be received by driver device interface module 208, and/or vehicle 101 may automatically provide information such as climate information based on vehicle 101 settings and/or cargo space information via onboard cameras and sensors. Additionally, driver device interface module 208 may receive information associated past deliveries performed by vehicle 101, delivery ratings from past deliveries, driver history, etc.

In addition, driver device interface module 208 may transmit a request to the driver device regarding a cargo delivery request by user device 110 and/or smart device 120 such that the user of the driver device may determine whether to pair/agree/accept the cargo delivery request. Accordingly, driver device interface module 208 further may receive an acceptance or rejection of the request by the driver device. In some embodiments, driver device interface module 208 may only receive vehicle information from vehicle 101 when vehicle 101 is within a predetermine geofence, and/or when the driver device is in a “discoverable” mode.

User device interface module 210 may be executed by processor 202 for interfacing with user device 110. For example, user device interface module 210 may receive information regarding a cargo delivery from user device 110 such as cargo size and/or climate preferences, if any, type of cargo, e.g., electronics, grocery, fragile, etc., and pick-up location and destination. Accordingly, the user of user device 110 may manually input cargo delivery information to be received by driver device interface module 208. In addition, user device interface module 210 may transmit vehicle information associated with vehicle 101 to user device 110, such that the user of user device 110 may determine whether to pair/agree with vehicle 101 to complete the cargo delivery. In some embodiments, user device interface module 210 may only transmit vehicle information associated with vehicle 101 to user device 101 and/or smart device 120 when vehicle 101 is within a predetermined geofence about user device 101 and/or smart device 120.

Route and cargo determination module 212 may be executed by processor 202 for pairing vehicle 101 and user device 110 and/or smart device 120, e.g., based on the vehicle information received by driver device interface module 208 and the cargo delivery information received by user device interface module 210. For example, route and cargo determination module 212 may determine a vehicle route of vehicle 101 based on the vehicle information, as well as a cargo delivery route based on the cargo delivery information. In addition, route and cargo determination module 212 may determine the amount of available cargo space in vehicle 101, e.g., a percentage of cargo space available, and optionally, the climate of vehicle 101 based on the vehicle information, as well as the cargo size to be delivered and additional cargo information such as climate preferences, if any, and type of cargo based on the cargo delivery information. Route and cargo determination module 212 further may estimate arrival time of vehicle 101 at the pick-up location specified by user device 110 as well as the time required for delivery.

Pairing module 214 may be executed by processor 202 for pairing vehicle 101 and user device 110 and/or smart device 120 based on, e.g., the vehicle route, the cargo delivery route, the amount of available cargo space in vehicle 101, the climate of vehicle 101, and/or the cargo size to be delivered and additional cargo information. For example, pairing module 214 may determine whether the cargo delivery requested by user device 110 is feasible and/or efficient for vehicle 101 to complete, e.g., whether the cargo delivery route deviates beyond a predetermined threshold of the vehicle route, whether the cargo size would fit within the available cargo space of vehicle 101 and/or whether the climate of vehicle 101 is aligned with the preference of user device 110. Accordingly, information regarding vehicle 101 may only be transmitted to user device 110 via user device interface module 210 if vehicle 101 is suitable for delivering the cargo as determined by pairing module 214.

In some embodiments, once user device 110 and the driver device and/or vehicle 101 are paired, driver device interface module 208 may instruct vehicle 101 to automatically drive to the pick-up location of the cargo delivery route, if user device 110 and the driver device agree. Moreover, driver device interface module 208 may instruct vehicle 101 to automatically drive from the pick-up location to the delivery destination along the cargo delivery route. In some embodiments, once user device 110 and the driver device and/or vehicle 101 are paired, driver device interface module 208 may instruct vehicle 101 to automatically adjust the cargo space and/or automatically adjust the seats within vehicle 101 to provide the necessary cargo space required to perform the requested cargo delivery by user device 110.

Smart device interface module 216 may be executed by processor 202 for receiving information from smart device 120. For example, if smart device 120 is a smart refrigerator, smart device interface module 216 may receive information indicative of grocery item(s) to be purchased/replaced, e.g., their size and climate requirement, if any, as described above. Accordingly, pairing module 214 may determine whether vehicle 101 is suitable for picking up and delivering the grocery item(s), and transmit the pairing to the driver device for acceptance/agreement.

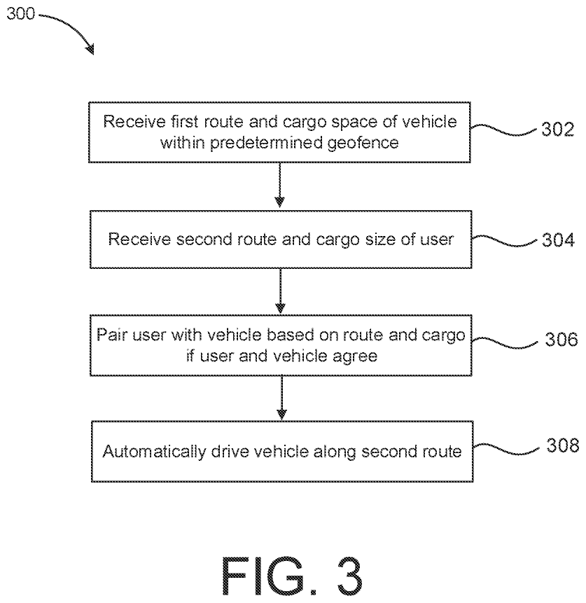

Referring now to FIG. 3, exemplary method 300 for providing a cargo marketplace is described. At step 302, cargo marketplace platform 200 may receive information indicative of the vehicle route of vehicle 101 as well as the available cargo space within vehicle 101 from the driver device associated with vehicle 101, e.g., if vehicle 101 is within a predetermined geofence. Alternatively, cargo marketplace platform 200 may receive the vehicle information, but only transmit the vehicle information to user device 110 when vehicle 101 is within a predetermined geofence about user device 110. At step 304, cargo marketplace platform 200 may receive information indicative of the cargo to be delivered from user device 110 and/or smart device 120, including, e.g., any climate preferences and cargo type. Cargo marketplace platform 200 may transmit the cargo information to the driver device and/or transmit the vehicle information to user device 110 so that the user of user device 110 and the user of the driver device may agree/accept or decline the delivery. For example, cargo marketplace platform 200 may only transit the vehicle information associated with vehicle 101 to user device 110 if vehicle 101 is within a predetermined geofence about user device 110.

At step 306, cargo marketplace platform 200 may pair the driver device and vehicle 101 with user device 110 if both users agree with the cargo delivery. At step 308, once user device 110 and the driver device and/or vehicle 101 are paired, vehicle 101 may automatically drive to the pick-up location of the cargo delivery route. Moreover, vehicle 101 may automatically drive from the pick-up location to the delivery destination along the cargo delivery route.

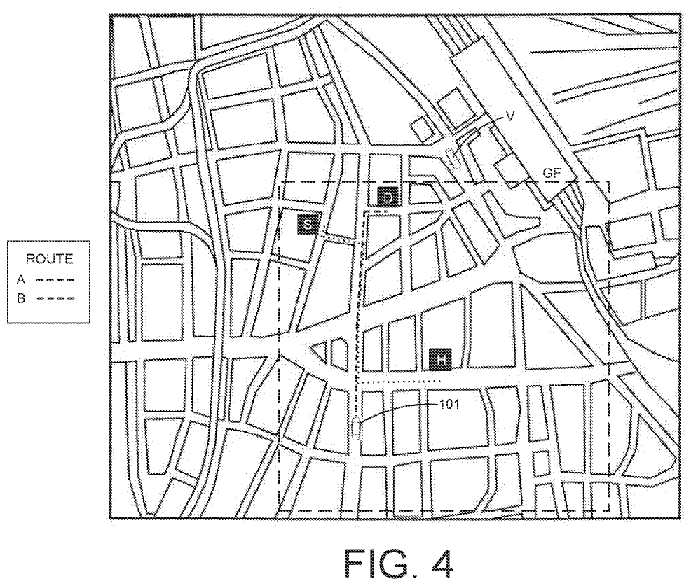

FIG. 4 illustrates an exemplary cargo marketplace. For example, vehicle 101 may be performing a predetermined navigation route, e.g., vehicle route A, from its current location to destination D. A user using user device 110 may need to have a piece of cargo delivered from home H to store S, e.g., via cargo delivery route B. As described above, cargo marketplace platform 200 may transmit vehicle information associated with vehicle 101 to user device 110 only when vehicle 101 is within geofence GF, and/or if vehicle 101 is in “discoverable” mode. In addition, cargo marketplace platform 200 may only transmit vehicle information associated with vehicle 101 to user device 110 if vehicle 101 is suitable for delivering the cargo based on, e.g., cargo size and climate. As shown in FIG. 4, the cargo delivery route B does not deviate very much from vehicle route A, and thus the user of user device 110 may choose to request for vehicle 101 to accept the delivery, and accordingly, the user of the driver device may choose to accept or decline the cargo delivery. If both users accept, user device 110 and vehicle may be paired for cargo delivery.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, and/or wireless data links) through a network, both perform tasks. In a distributed system environment, program modules may be located in both the local and remote memory storage devices.

Further, where appropriate, the functions described herein may be performed in one or more of hardware, software, firmware, digital components, or analog components. For example, one or more application specific integrated circuits (ASICs) may be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed:

1. A system for providing a cargo marketplace, the system comprising:
a memory that stores computer-executable instructions; and
a processor configured to access the memory and execute the computer-executable instructions to:
receive information indicative of a first route and a cargo size from a user device;
receive information indicative of a second route and a cargo space from a driver device associated with a vehicle if the driver device is within a predetermined geofence of the user device;
pair the driver device and the user device based on the first route and the second route and the cargo size and the cargo space if the user device and the driver device agree.

2. The system of claim 1, wherein the processor is configured to receive information indicative of the second route and the cargo space from the driver device if the driver device is within the predetermined geofence of the user device automatically.

3. The system of claim 1, wherein the processor is configured to receive information indicative of the second route and the cargo space from the driver device if the driver device is within the predetermined geofence of the user device if the driver device is in a discoverable mode.

4. The system of claim 1, wherein the processor is further configured to transmit information indicative of the second route and the cargo space to the user device to facilitate agreement by the user device.

5. The system of claim 1, wherein the processor is further configured to transmit information indicative of the first route and the cargo size to the driver device to facilitate agreement by the driver device.

6. The system of claim 1, wherein the processor is further configured to receive information indicative of driver history including previous delivery information from the driver device, and wherein the processor is configured to pair the driver device and the user device based on the driver history if the user device and the driver device agree.

7. The system of claim 1, wherein the processor is further configured to:
receive information indicative of vehicle climate from the driver device; and
receive information indicative of climate preference from the user device,
wherein the processor is configured to pair the driver device and the user device based on the vehicle climate and the climate preference if the user device and the driver device agree.

8. The system of claim 1, wherein the processor is further configured to:
receive information indicative of location and speed of the vehicle from the driver device; and
transmit the information indicative of the location and speed of the vehicle to the user device to facilitate agreement by the user device.

9. The system of claim 1, wherein the processor is further configured to:
receive information indicative of a third route and a second cargo size from a smart device; and
pair the driver device and the smart device based on the second route and the third route and the second cargo size and the cargo space if the smart device and the driver device agree.

10. The system of claim 9, wherein the smart device is a smart refrigerator, and wherein the second cargo size comprises a grocery size and wherein the smart refrigerator is configured to learn a user's grocery preferences based on past grocery purchases

11. The system of claim 1, wherein the processor is further configured to instruct the vehicle to automatically drive to a pick up location of the second route if the user device and the driver device agree.

12. A method for providing a cargo marketplace, the method comprising:
receiving information indicative of a first route and a cargo size from a user device;
receiving information indicative of a second route and a cargo space from a driver device associated with a vehicle if the driver device is within a predetermined geofence of the user device;
pairing the driver device and the user device based on the first route and the second route and the cargo size and the cargo space if the user device and the driver device agree.

13. The method of claim 12, further comprising:
transmitting information indicative of the second route and the cargo space to the user device to facilitate agreement by the user device.

14. The method of claim 12, further comprising:
transmitting information indicative of the first route and the cargo size to the driver device to facilitate agreement by the driver device.

15. The method of claim 12, further comprising:
receiving information indicative of location and speed of the vehicle from the driver device; and
transmitting the information indicative of the location and speed of the vehicle to the user device to facilitate agreement by the user device.

16. The method of claim 12, further comprising:
receiving information indicative of driver history including previous delivery information from the driver device; and
pairing the driver device and the user device based on the driver history if the user device and the driver device agree.

17. The method of claim 12, further comprising:
receiving information indicative of vehicle climate from the driver device;
receiving information indicative of climate preference from the user device; and
pairing the driver device and the user device based on the vehicle climate and the climate preference if the user device and the driver device agree.

18. The method of claim 12, further comprising:
receiving information indicative of a third route and a second cargo size from a smart device; and
pairing the driver device and the smart device based on the second route and the third route and the second cargo size and the cargo space if the smart device and the driver device agree.

19. The method of claim 18, wherein the smart device is a smart refrigerator, and wherein the second cargo size comprises a grocery size.

20. The method of claim 19, wherein receiving information indicative the third route and the second cargo size from the smart refrigerator comprises automatically receiving information indicative the third route and the second cargo size from the smart refrigerator based on learned grocery preferences based on past grocery purchases of a user.
